(19) United States
(12) Patent Application Publication
(10) Pub. No.: US 2015/0381926 A1
(43) Pub. Date: Dec. 31, 2015

(54) Synchronous Capturing, Storing, and/or Providing Data From Multiple Sources

(71) Applicant: Sport Scope Inc.

(72) Inventors: Derek Taylor, Coeur d'Alene, ID (US); Daniel Schwartz, Spokane, WA (US); Nathan Dunlap, Spokane, WA (US)

(21) Appl. No.: 14/317,267

(22) Filed: Jun. 27, 2014

(51) Int. Cl. H04N 5/92; H04N 7/18

(52) U.S. Cl. CPC H04N 5/9205; H04N 7/181

(57) ABSTRACT

This disclosure describes, in part, techniques and systems for capturing, storing, editing, and distributing synchronized data captured from multiple sensing devices. The data may be captured from the multiple sensing devices located a multiple locations. The data may be synchronized by instructing a capture card from each sensing device to simultaneously record the data provided by the multiple sensing devices. The synchronized data may be provided to other electronic devices for replay and/or provided to a data hosting service for editing.

### BACKGROUND

Having access to replay video can be useful in many different scenarios. For instance, in athletics, replay video can help a coach correct a player's mistake during a game/practice and/or help an official correct an incorrect on-field call. Furthermore, having access to replay video recorded from multiple electronic devices from multiple angles may provide an even better tool since the player and/or play may be better viewed from the multiple angles. However, in traditional replay systems using multiple electronic devices, synchronizing the video is difficult since each recording device may require a separate user to initiate capture of the video. Such lack of synchronization may make editing and/or uploading of the multiple video angles to an editing service difficult and time intensive.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of an illustrative environment for capturing synchronized data from multiple data sources.

FIG. 2 is a block diagram of an illustrative computing architecture to capture, store and/or provide synchronized data.

FIG. 3 is an example user interface to allow a user of the system to create a new data file prior to capturing data.

FIG. 4 is an example user interface to allow a user to edit and/or select data for viewing.

FIG. 5 is an example user interface to allow a user to view and/or edit data captured by one or more capture cards.

FIG. 6 is a flow diagram that illustrates an example process of capturing synchronized data from a set of data sources, storing the data, and providing the data to one or more electronic devices.

FIG. 7 is a flow diagram that illustrates an example process of presenting synchronized data segments on a computing device.

### DETAILED DESCRIPTION

### Overview

This disclosure describes, in part, techniques for capturing, storing, editing, and/or distributing synchronized data captured from multiple data sources. The captured video from each of the multiple data sources may be synchronized and able to display and/or play multiple angles of the captured video. In some implementations, the video is synchronized while it is captured from each of the multiple data sources. In some implementations, the captured video, including the synchronized multiple angles of video from each of the multiple data sources, may be automatically uploaded (or prepared to be uploaded) to a video hosting service for editing. In some implementations, the captured video, including the synchronized multiple angle of video from each of the multiple data sources, may be distributed over a network to one or more electronic devices for playback.

To illustrate, envision a user, such as a football coach, utilizes the systems and methods described herein to assist him/her in instructing his/her players during a game. The system may receive data from one or more data sources positioned at multiple locations. In some implementations, a data source may be a video sensing device such as a camera or camcorder. For instance, in the football context, a High-Definition (HD) camcorder placed beyond an end zone of a field of play may provide video from a first angle while another HI camcorder may be placed in the press box (or other location on the sidelines of the field of play) may provide video from a second angle. In addition, the system may include a control to instruct a capture device dedicated to each camcorder to simultaneously begin capture of the video data and simultaneously end capture of the video data provided by each camcorder. In some implementations, the captured video from each camcorder is recorded by a capture card dedicated to each individual camcorder. For instance, a first HDMI capture card may capture the video provided by the end zone camcorder while a second HDMI capture card may capture the video provided by the press box camcorder. In this instance, the video captured from each camcorder may be synchronized automatically at the time of capture.

In some implementations, the system may store the synchronized video provided by each data source and captured by each corresponding capture device.

The system may use one or more network(s) to present the stored synchronized video from the multiple data sources to the football coach. For instance, the football coach, standing on the sidelines (i.e., remote from the video storage location) may use a dedicated application on a portable electronic device to display the stored synchronized video captured from multiple angles to show a player how to correct a mistake captured in the video. In some implementations, the stored synchronized video is available for display immediately after it is captured and stored.

In some implementations, the system may allow the stored synchronized video to be edited. For instance, the system may include one or more user interfaces presented to the football coach on an electronic device as part of the application to allow the coach to edit the stored synchronized video.

In some implementations, the system may use the network(s) to provide the stored synchronized video to a video editing service, video hosting service (e.g., Hudl®), social network sites, etc. In some implementations, the system may automatically communicate the stored synchronized video to a video editing service, video hosting service (e.g., Hudl®), social network sites, or the like, via an application programming interface of the site without specific interaction required by the user.

The techniques for capturing, storing, editing, and/or distributing video recorded from multiple data sources may be implemented in a number of ways. Example implementations are provided below with reference to the following figures.

### Illustrative Environments

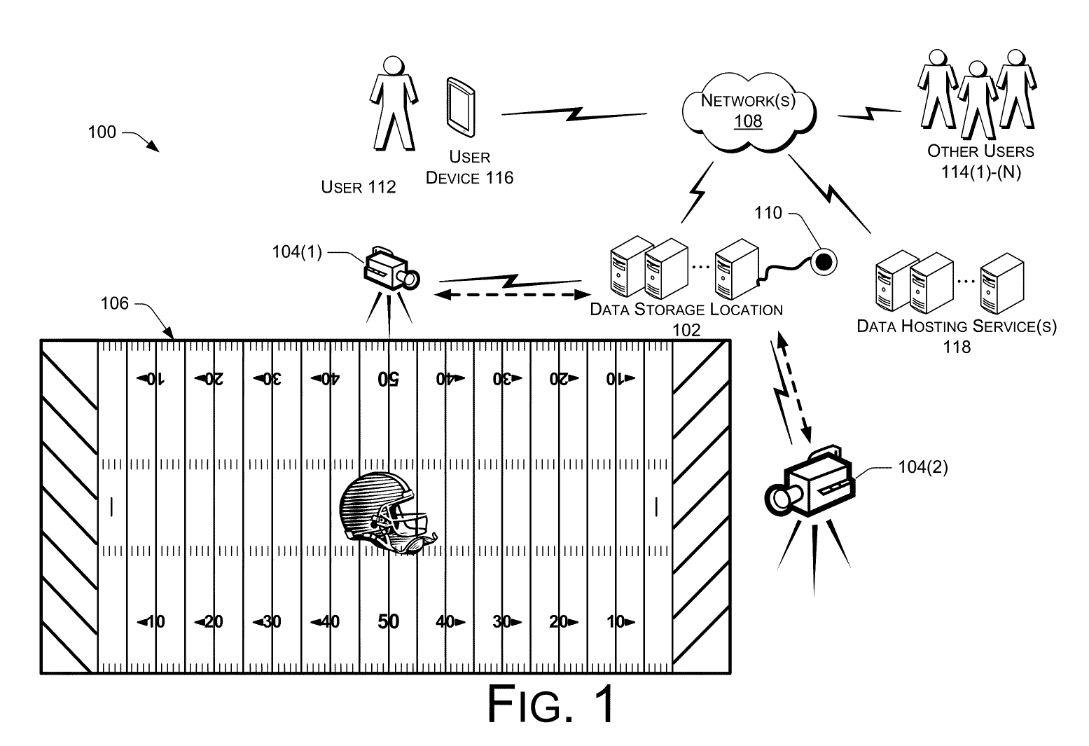

FIG. 1 is a schematic diagram of an illustrative environment 100 of a system for capturing, storing, editing, and distributing data recorded from multiple data sources. As illustrated, environment 100 may include a data storage location 102 (“storage location”) which may synchronize and store data (e.g., video and/or audio) provided by data sources such as sensing devices 104(1) and 104(2). Environment 100 illustrates two data sources; however, in other implementations, the storage location may receive data provided by any number of data sources (i.e. one, two, three, five, ten, etc.). Sensing devices 104(1) and 104(2) (or any additional data sources) may include any type of electronic device or computing device that can sense, capture, and/or otherwise provide video and/or audio data. For example, the sensing devices 104(1) or 104(2) may be any one of a digital camcorder (HD or standard definition), video camera, smart telephones, microphones, and/or tablets.

In some implementations, each sensing device 104(1) and 104(2) may be positioned such that the data provided from each sensing device is of the same scene but from different vantages or angles than each other sensing device. For instance, environment 100 illustrates that sensing device 104(1) may be positioned on the sideline of a football field 106 while sensing device 104(2) is illustrated as positioned on an end of the football field 106. In other implementations, it is to be understood that each sensing device may be positioned in any number of positions relative to the data they are intended to collect or sense. For instance, a sensing device may be player-mounted, official-mounted, ball mounted and so forth. In some implementations, one or more sensing devices may be stationary and/or mobile relative to the data they are intended to sense. Furthermore, while FIG. 1 illustrates environment 100 in the context of football field 106, the techniques for capturing, storing, editing, and/or distributing data recorded from multiple sensing devices may be implemented in many different scenarios. For example, the techniques may be used in the context of other sporting events (e.g., basketball, lacrosse, hockey, baseball, water polo (including underwater sensing device(s)), soccer, etc,), theatrical performances, dance recitals, security surveillance, among others.

The storage location 102 may include one or more capture cards (not shown in this figure) for receiving data provided by the sensing devices 104(1) and 104(2). For instance, the capture cards may include one or more HDMI video capture cards, serial digital interface (SDI) video capture cards, high definition serial digital interface (HD-SDI) video capture cards, standard definition (SD) video capture cards or the like. In some implementations, the received data may be stored by one or more memories of the storage location 102. The memories may be one or more of hard disk drive(s), flash drive(s), secure digital (SD) memory, solid-state drive(s) (SSD) or other mass storage device(s). In some implementations, the storage location 102 may use network(s) 108 via one or more network-attached storage (NAS) hard drives or solid-state/flash memory to store the captured data remote from the storage location 102.

In some implementations, each capture card of the storage location 102 may receive the data provided by a specific sensing device where each sensing device continuously provides the data. For instance, where there are two sensing devices, 104(1) and 104(2) as illustrated in FIG. 1, the storage location 102 may include two capture cards (i.e., one capture card receiving the data from sensing device 104(1) and another capture card receiving the data from sensing device 104(2)). As illustrated in FIG. 1, the storage location 102 may communicate with one or more sensing devices 104(1) and 104(2) via a wireless network. Additionally or alternatively, the one or more sensing devices 104(1) and 104(2) may provide data to the storage location 102 via a direct or wired connection.

FIG. 1 also illustrates a physical or soft controller 110 (e.g., button, switch, knob, key, and so forth) which may direct the capture cards and memories of the storage location 102 to initiate or begin storing the data provided by each corresponding sensing device 104(1) and 104(2). Subsequently, controller 110 may also indicate that the capture cards and memories of the storage location 102 may stop storing the data provided by each corresponding sensing device 104(1) and 104(2). That is, controller 110 initiates a signal to simultaneously activate/deactivate the capture cards to capture/stop capturing the data (e.g., video/audio) from the respective sources. In this instance, controller 110 may produce data segments stored in the memories having synchronized data from sensing device 104(1) and sensing device 104(2).

Controller 110 is illustrated as attached to the storage location 102. In this implementation, the controller 110 may be operated by a user proximate to the storage location 102. However, in other implementations, controller 110 may be remote from the storage location 102 and may be presented in a user interface on a device that is not attached to and may be remote from the storage location 102. For instance, as described below, controller 110 may be presented to user 112 on user device 116 as part of an application for viewing/editing the data segments. In some implementations, the controller 110 may be located at one of the sensing devices.

The storage location 102 may communicate with other computing devices or servers via one or more networks 108. The networks 108 may include wireless and/or wired networks, including mobile telephone networks, wide area networks (WANs), and so forth.

The storage location 102 may communicate with one or more users, which may include user 112 and the other users 114(1)-(N). User 112 may use a device 116 to communicate with the storage location 102 to display, view, and/or edit the data segments stored by storage location 102 after the data segments are captured from each of the sensing devices 104(1) and 104(2). The device 116 may include virtually any type of electronic device or computing device that can exchange information with another device. For example, the device 116 may be any one or more of a mobile telephone, smart telephone, notebook computer, tablet, gaming console, desktop computer, kiosk, and/or other types of electronic device. The storage location 102 may provide the stored data to the device 116 (or any other device) through a browser, a dedicated application or “app”, and/or through messaging services such as multimedia message service (MMS), email, and other messaging services.

In some implementations, the storage location 102 may communicate with one or more data hosting services 118 (“hosting service”) via the networks 108. In some implementations, the hosting services 118 may allow a user 112 to edit the synchronized data segments stored by the storage location 102. In some implementations, the synchronized data segments stored by the memories of the storage location 102 may be provided via the network(s) 108 to the hosting service 118 without interaction with a user. For instance, once an account with the hosting service 118 is established, the storage location 102 may upload the stored synchronized data segments to the hosting service immediately after the synchronized data segments are received by the capture cards and stored by the memories of the storage location 102. In some implementations, the storage location 102 may upload the stored synchronized data segments to the hosting service by a dedicated application programming interface (API) allowing the components of the storage location 102 to directly interact with the components of the hosting service 118.

### Illustrative Data Storage Location Architecture

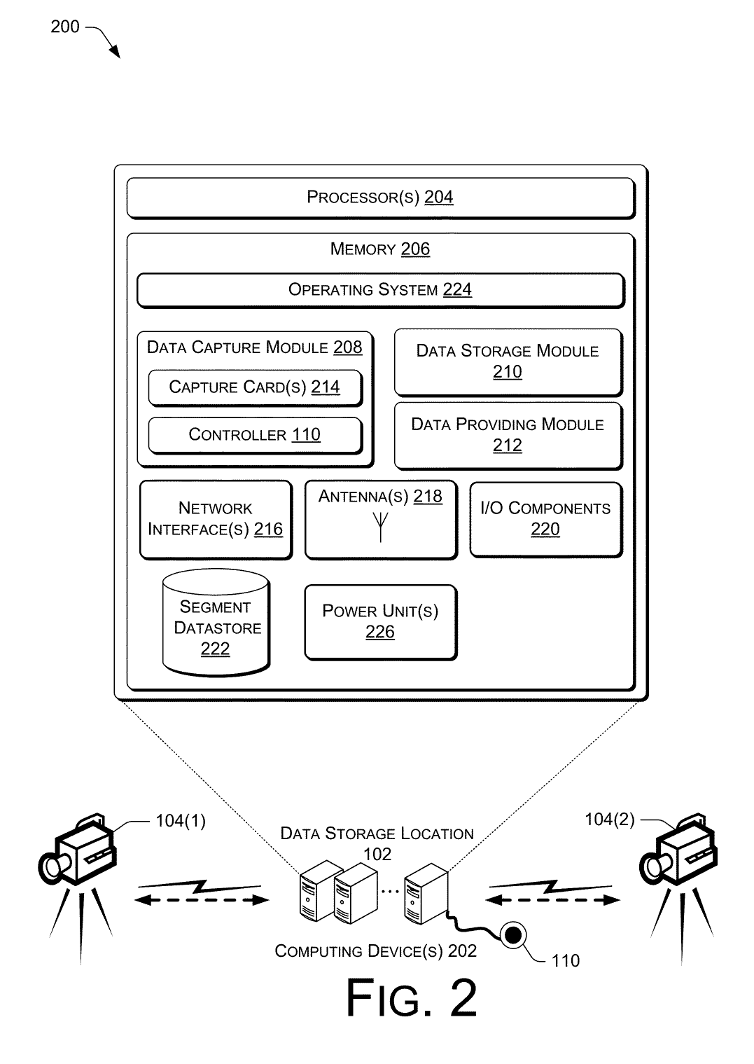

FIG. 2 shows a block diagram of an illustrative computing architecture 200 of the storage location 102 that captures data provided by multiple sensing devices. In some implementations, the storage location 102 may include one or more computing devices 202 that may be implemented in a distributed or non-distributed computing environment.

The computing devices 202 may include one or more processors 204 and memory 206 which may store various modules, applications, programs, or other data. The memory 206 may include instructions that, when executed by the one or more processors 204, cause the processors to perform the operations described herein for the storage location 102.

The memory 204 may include computer-readable storage media (“CRSM”), which may be any available physical media accessible by the processor 202 to execute instructions stored on the memory. In one basic implementation, CRSM may include random access memory (“RAM”) and Flash memory. In other implementations, CRSM may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or any other medium which can be used to store the desired information and which can be accessed by the processor 202.

Implementations may be provided as a computer program product including a non-transitory CRSM having stored thereon instructions (in compressed or uncompressed form) that may be used to program a computer (or other electronic device) to perform processes or methods described herein. Further, implementations may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be by an Internet download.

In some implementations, the memory 206 may store a data capture module 208, a data storage module 210, and a data providing module 212, each of which are described in detail below. The modules may be stored together or in a distributed arrangement. In some implementations, the modules may represent services that may be performed using components that are provided in a distributed arrangement, such as by virtual machines running in a cloud computing environment.

In some implementations, the data capture module 210 may use hardware such as one or more capture cards 214 and a controller 110 to allow for capture of data from the one or more sensing devices. As mentioned above with reference to FIG. 1, a number of capture cards may, in some examples, correspond to a number of sensing devices. For instance, where the system includes two sensing devices 104(1) and 104(2), the computing architecture 200 may include two capture cards 214 where each sensing device 104(1) and 104(2) has a dedicated capture card (e.g., 214(1) and 214(2), respectively) to receive the data provided by the specific sensing device. In some implementations, individual capture cards 214 may receive only video data from the sensing devices 104(10 and 104(2). In other implementations, individual capture cards 214 may receive video and audio data from the sensing devices 104(1) and 104(2). Furthermore, individual capture cards 214 may receive one of standard definition video or HD video. In some implementations, there may not be a one to one correspondence between the capture cards and the sensing devices. For instance, a single capture card may receive data from multiple sensing devices, or multiple capture cards may receive all or part of data from a single sensing device.

In some implementations, the data capture module 210 may receive the data from the one or more sensing devices via a network interface 216 which facilitates a wired and/or wireless connection to a network(s) 108. As mentioned above, the data provided by individual sensing devices 104(1) and 104(2) may be received at the data capture module 210 via a wired and/or wireless connection to a network(s) 108. In some implementations, the computing architecture and one or more sensing device(s) may include one or more antenna(s) 218 coupled to the network interface(s) 216 to aid in wireless data reception and/or transmission. The network interface(s) 216 may implement one or more of various wireless technologies, such as WiFi, Bluetooth, radio frequency (RF), and so on.

Controller 110 included in the data capture module 208 may allow a user of the computing device 202 to provide an indication to the capture card(s) 214 to begin and/or stop capturing the data received from the sensing devices. For instance, upon receiving an indication for controller 110, each capture card 214 may begin writing the data received from each sensing device to a data file or multiple data files. Controller 110 may allow the data received by capture cards from individual corresponding sensing devices to be synchronized since the control of the data capture from all capture cards is controlled at a single location (i.e., with controller 110). In some implementations, the data capture module 208 may create one or more synchronized data segments. Individual synchronized data segments may represent a portion of data captured by individual capture cards from the corresponding sensing devices which are divided by the begin/stop indication provided by controller 110.

In some implementations, the individual sensing devices may be left to continually monitor a desired target (e.g., player on a field) while the actual capturing of the data from each of the sensing devices is controlled by the controller 110. In some implementations, controller 110 removes latency, delay, and/or lag time of a controller that merely instructs, via a wireless network, a sensing device to initiate/stop recording of a desired target since the sensing devices, as described herein, are already providing the data to the a corresponding capture card for recording.

As illustrated, controller 110 may be a physical button located proximate and/or attached to the computing device 202. For instance, the controller 110 may be attached to the computing device 202 via an I/O component 220, such as a USB port, a Firewire® port, a HDMI port, or the like. In some implementations, the controller 110 may include an indicator (e.g., a light emitting diode (LED)) that when lit may provide a visual indication that the capture card(s) 214 are currently receiving data from the sensing devices. However, in other implementations, the controller 110 may be remote from the computing device 202. For instance, the controller 110 may be integrated with an application controlling the functionality of the storage location 102, while the application may be displayed on a portable electronic device. In other implementations, the controller may be a physical controller attached to the portable electronic device controlling the functionality of the storage location 102. In either implementation, the controller 110 may be utilized over the network 108 to provide an indication to the capture card(s) 214 to begin and/or stop capturing the data received from the sensing devices. In some implementations, the controller 100 may be located at a sensing device.

As mentioned above, the computing architecture 200 includes a data storage module 210 to store the synchronized data segment(s) created by the data capture module 208. In some implementations, the data storage module 210 may store the synchronized data segment(s) in one or more datastores. For instance, the synchronized data segment may be stored permanently or temporarily in the segment datastore 222. In some implementations, the synchronized data segments may be stored locally on the memory 206 of the computing device 202. However, in some implementations, the data providing module 212 (described below) may provide the synchronized data segments to a remote storage location.

In some implementations, the synchronized data segments may be stored by the data storage module 210 in chronological order based on the order each synchronized data segment was created. In some implementations, each synchronized data segment may be time-stamped by the data storage location 210. The time-stamp may indentify a date and/or time that each synchronized data segment was created. In some implementations, the time-stamp may include additional information corresponding to a point during a scene that each synchronized data segment was created (e.g., a period, half, quarter, a time remaining in a period, half, or quarter, an inning, or pitch count, etc.) or the tagged players within the synchronized data segment. In other implementations, the data storage module 210 may separately store each synchronized data segment based on where the data segment contains data of a particular type. For instance, the data storage module 210 may place a data segment containing an offensive play in a first datastore while placing a data segment containing a defensive play in a second datastore.

In some implementations, the data storage module 210 may store edits made to one or more of the synchronized data segment(s). For instance, a user may provide information (e.g., file name, tagged humans/events captured in the data segment, time of the data segment, voice-over audio corresponding to the data segment, etc.) corresponding to the data segment for future use. In some implementations, when the information is provided by the user the data storage module 210 may overwrite a previously stored file corresponding to the data segment without the new information.

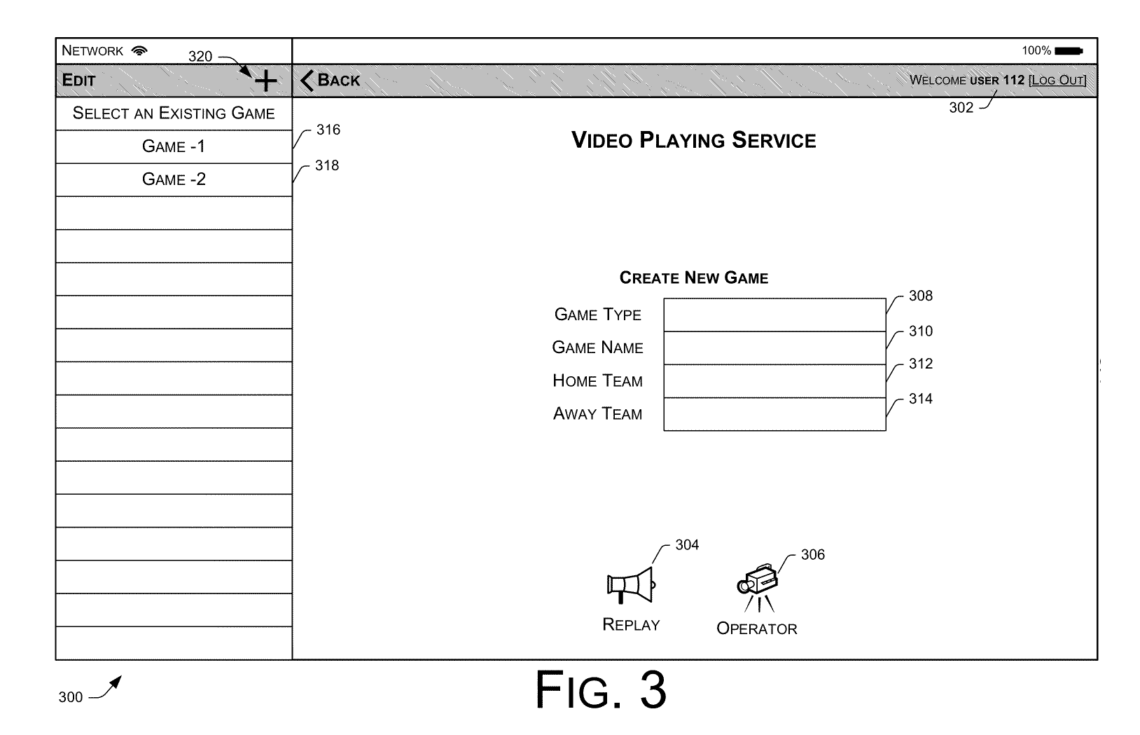

As mentioned above, the computing architecture 200 includes a data providing module 212 which may provide the synchronized data segments to one or more electronic devices and/or a data hosting service. In some implementations, the data providing module 212 may provide, via network(s) 108 as illustrated in FIG. 1, one or more synchronized data segments to one or more electronic devices for playback and/or editing. Example electronic devices may include mobile telephones, smart telephones, notebook computers, tablets, kiosks, and/or other types of electronic devices. As mentioned above, the data providing module 212 may provide one or more synchronized data segments to one or more electronic device(s) through a browser or a dedicated application or “app.” As described below in FIGS. 3-5, the dedicated application may have various user interfaces (UI) for receiving, viewing, and/or editing the synchronized data segments. For instance, a UI may allow a user to name and/or timestamp one or more synchronized data segments.

In some implementations, the data providing module 212 may provide the synchronized data segments to one or more data hosting services. For instance, once a synchronized data segment is stored by the data storage module 210, the data providing module 212 may upload the stored synchronized data segment to a hosting service. In some implementations, the hosting service may be a video hosting service such as, for example, Hudl®. The video hosting service may allow for editing and/or further dissemination of the synchronized data segment. In some implementations, the upload to the data hosting service may be completed immediately after each synchronized data segment is stored in by the data storage module 210 without addition interaction from a user. For instance, the data hosting service may offer an application program interface (API) to allow the data providing module 212 to call the data hosting service via the network(s) 108 to upload the synchronized data segments without direct user interaction. In other implementations, the upload of multiple synchronized data segments may be uploaded in batches, at specific time designated by a user, and/or at a time when the computing device connects to a particular network.

In some implementations, the data providing module 212 may pack, compress and/or format each data segment to accommodate requirements of the one or more electronic devices and/or the data hosting service.

An operating system 224 may be configured to manage hardware and services (e.g., capture card(s) 214, controller 110, network interface 216, I/O components 220 (e.g., USB, HDMI, etc.)) within and coupled to the computing device(s) 202 for the benefit of other modules. A power unit 226 is further provided to distribute power to and manage power consumption by the various components on the computing device(s) 202.

### Illustrative User Interfaces

FIGS. 3-5 illustrate various example user interfaces for playback and/or editing the synchronized data segments on an electronic device, such as device 116 of the user 112. More specifically, the example user interfaces may be generated by the dedicated application stored on the electronic device and may be configured to receive the synchronized data segments from the data providing module 212 as described above.

FIG. 3 illustrates an example user interface 300 generated by an application stored on an electronic device which interacts with data providing module 212 to allow a user to create a new data file prior to capturing data. For instance, in the context of FIG. 1, example user interface 300 may be presented on the user device 116 in order for user 112 to input details of a new football game or practice to associate the data captured by the data capture module 208 and provided by the data providing module 212.

As illustrated in FIG. 3, example user interface 300 may include a location 302 illustrating that a user may be currently logged into the application of the storage location 102. For instance, FIG. 3 shows at location 302 that user 112 is logged onto the application of the storage location 102.

In some implementations, upon logging in and/or activation of the application, example user interface 300 may present a location for selection of a replay function 304 and an operator function 306. The replay function 304 may allow a user of the electronic device to input information corresponding to a new data file and/or select an existing data file for viewing on the electronic device. While, the operator function 306 may allow a user of the electronic device to operate the control of the one or more data sources or sensing devices. For instance, the operator function may provide access to the functionality described above of controller 110 so the user 112 may start and stop the capture cards of 214 of the data capture module 208 from capturing the data from each of the sensing devices. In some implementations, the operator function 318 may allow the user 112 to use a camera of the electronic device as another sensing device for providing data to the storage location 102.

In some implementations, upon selection of the replay function 304, multiple locations for input of information corresponding to a new data file may be presented in example user interface 300. For instance, example user interface 300 may include a location 308 for input of information corresponding to a game type (e.g., football, soccer, basketball, etc.), a location 310 for input of information corresponding to a game name (e.g., “Varsity Jun. 12, 2014 Practice,” Tigers v. Saxons, etc.), a location 312 for input of information corresponding to a home team, and a location 314 for input of information corresponding to an away team. In other implementations, example user interface 300 may include other locations for input of information corresponding to the new date file (e.g., date, time, and/or geographic location, etc).

In some implementations, the example user interface 300 may allow a user to view archived data that was previously captured and stored. In some implementations, example user interface 300 may include a location for selection of an existing file. For instance, example user interface 300 shows a location 316 and 318 for selection of “Game −1” or “Game −2”, respectively. In some instances, the user device 116 may include touch sensor(s) to provide a touch-sensitive display that displays example user interface 300 (and any other interface described herein) and allows users to navigate via touch inputs. In some instances, the touch sensor(s) are capable of detecting touches as well as determining an amount of pressure or force of touch inputs.

Example user interface 300 also illustrates an edit function. In some implementations, the edit function may be initiated by the selection of plus sign 320. In some implementations, the edit function may allow a user to alter the information associated with an existing data file. For instance, the edit function may allow a user to change the name of a previously created data file.

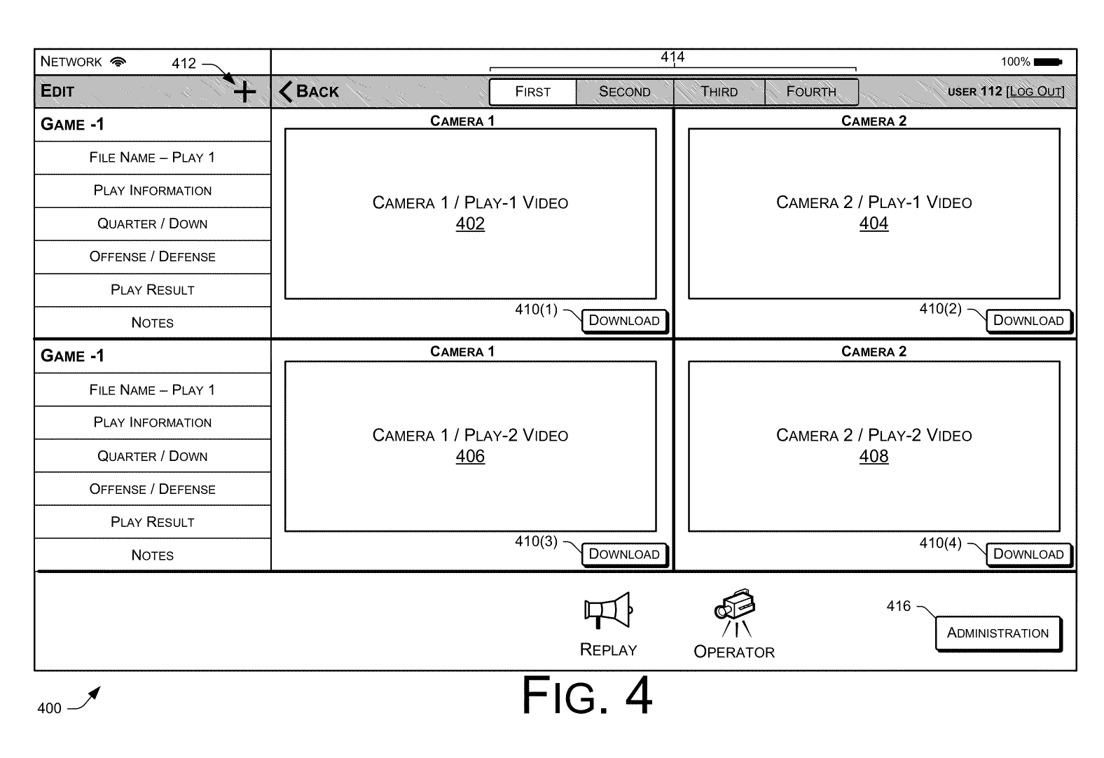

FIG. 4 illustrates an example user interface 400 generated by the application stored on the electronic device which interacts with the data providing module 212 to allow a user to view data captured by the capture cards from the sensing devices. In some implementations, the example user interface 400 may allow a user to select one of the synchronized data segments stored by the data storage module 210.

For instance, envision that user 112 has selected “Game −1” from the example user interface 300. In some implementations, as a result of the selection, example user interface 400 may receive from the data providing module 212 one or more synchronized data segments corresponding to “Game −1”.

As illustrated, example user interface 400 may include a first preview window 402 for displaying a video segment of a “Play −1” as provided by a specific sensing device or “Camera 1”. While the example user interface 400 may also include a second preview window 404 for displaying a video segment of a “Play −1” as provided by another specific sensing device or “Camera 2”.

In some implementations, the example user interface 400 may include other preview windows, such as window 406 and 408, for displaying additional synchronized data segments corresponding to “Game −1”. In some implementations, each preview window may have a control such as control 410(1)-(4) for downloading the corresponding play or data segment to the electronic device for viewing while the electronic device may not be connected to a network.

Example user interface 400 may include additional information corresponding to the play or data segment provided by the data providing module 212 of the storage location 102. In some implementations, the additional information may include a file name of the play or data segment, play formation information, time in the game (e.g., quarter, down, period, half, etc.), whether the play or data segment is categorized as on offense or defense, the result of the play or data segment, and/or miscellaneous notes on the play or data segment. In some implementations, the additional information may be added prior to providing by the data providing module 212; however, in some implementations, the additional information may be added and/or edited by user 112 interacting with the application. For instance, user 112 may select an edit function at plus sign 412 to alter the information associated with the play or data segment.

Example user interface 400 may include a location 414 for selection of a point or a time period of a data segment. For instance, location 414 may allow the user to filter the displayed synchronized data segments by a quarter. In other implementations, the location 414 may include additional filters to limit display of the synchronized data segments depending on the event captured from the sensing devices and sent to the storage location 102. For instance, the location 414 may allow for selection of periods, halves, innings, overs, and/or a specific time period within each.

In some implementations, the example user interface 400 may include an administration function 416. In some implementations, the administration function 416 may allow a user to remotely access the storage location 102 to remove data segments stored by the data storage module 210. In some implementations, the administration function 416 may allow a user to remotely alter which data segments are uploaded to the data hosting service. In yet another implementation, the administration function 416 may allow a user to download all or a set of synchronized data segments to an electronic device.

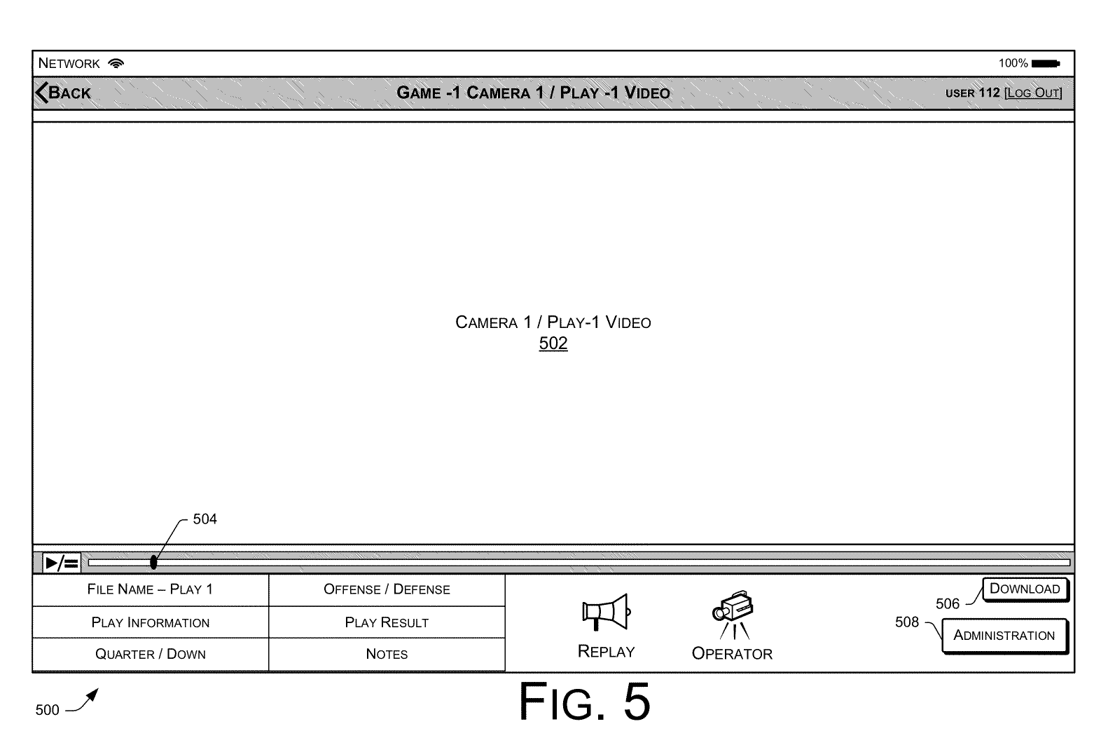

FIG. 5 illustrates an example user interface 500 generated by the application stored on the electronic device which interacts with the data providing module 212 to allow a user to view data captured by the capture cards. In some implementations, the example user interface 500 may allow a user to play one or more of the synchronized data segments stored by the data storage module 210.

Example user interface 500 may include a viewing window 502 for playing a data segment provided by a specific sensing device, captured by the corresponding capture card, and stored by the data storage module 210. In some implementations, the example user interface 500 may include a plurality of viewing windows for playing synchronized data segments captured from multiple sensing devices. In some implementations, example user interface 500 may allow a user to simultaneously play each data segment of the synchronized data segment in side-by-side viewing windows. In other implementations, each data segment of the synchronized data segments may be presented in side-by-side viewing windows while the user may select a particular data segment to view.

Example user interface 500 may allow a user, such as user 112, who may be remote from the storage location 102 to view a particular play or data segment via the application on the electronic device. For instance, envision that user 112 has selected “Game −1 Camera 1/Play −1” from the example user interface 400. In some implementations, as a result of the selection, example user interface 500 may receive from the data providing module 212 the data segment corresponding to “Game −1 Camera 1/Play −1”.

In some implementations, example user interface 500 may be controlled by one or more touch inputs. For instance, user 112 may touch any area within the viewing window 502 to start/stop/pause the display of the data segment presented within the viewing window. In some implementations, the user may use the slidebar 504 to start/stop/pause the display of the data segment presented within the viewing window. In some implementations, the slidebar 504 may allow a user to view the data segment presented within the viewing window in slow motion(e.g., frame by frame, quarter speed, half speed, etc) and/or fast forward to a particular point within the data segment.

Touch input, such as a left, right, up, or down swipe, may allow a user to change display of the data segment displayed within the viewing window 502. For instance, a left swipe or a right swipe on the screen of the electronic device may allow the user to change the data to show a data segment as provided by another sensing device (i.e., from Camera 1 to Camera 2 for the same play). In other implementations, an up or a down swipe may allow the user to change the data to show a different data segment from the data segment initially displayed (i.e., Play −1 to Play −2 captured from the same sensing device).

In some implementations, example user interface 500 may allow a user to edit the data segment displayed in the viewing window 502. For instance, a user may select one or more features presented in the data segment, such as a player, to highlight the player. In some implementations, the user may tag the data segment as containing certain features and/or characters. As described above, such tags or highlights made by the user may be saved with the data segment by the data storage module 210. In some implementations, one or more tags or highlights made in a data segment may be reproduced in another data segment, such as a corresponding data segment captured from another sensing device.

Example user interface 500 may include a location for display of information corresponding to the data segment currently displayed in the viewing window 502. For instance, the information may include a file name of the play or data segment, play formation information, time in the game (e.g., quarter, down, period, half, etc.), whether the play or data segment is categorized as on offense or defense, the result of the play or data segment, and/or miscellaneous notes on the play or data segment.

Example user interface 500 may also include a control 506 for downloading the data segment currently displayed in the viewing window 502. In some implementations, example user interface 500 may include an administration function 508 which may have similar functions as described above with reference to FIG. 4.

### Illustrative Processes

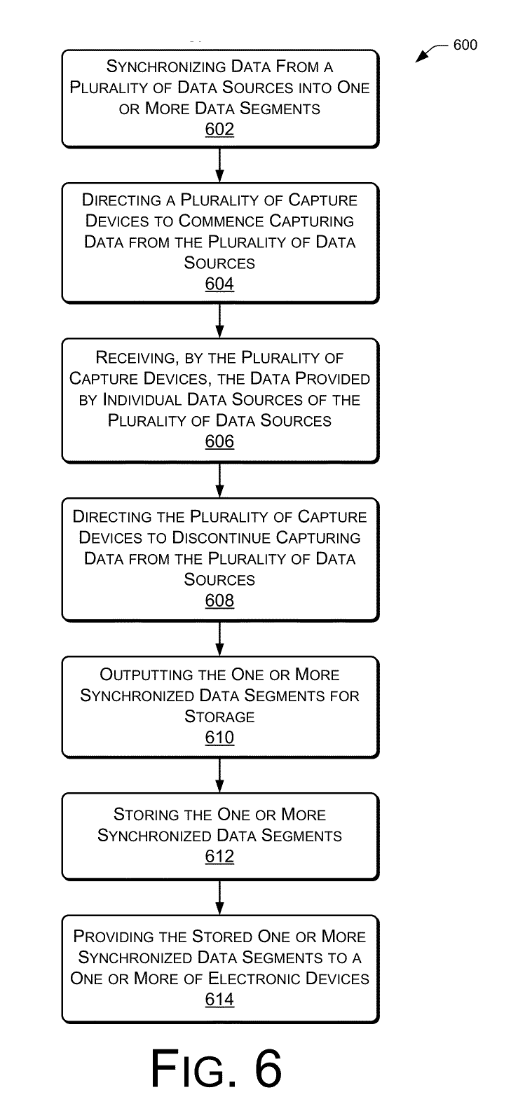

FIG. 6 is a flow diagram of an illustrative process 600 for implementing the techniques described above of storing, editing, and/or distributing video captured from multiple data sources. The processes (and the other processes herein) are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. Furthermore, the processes are described with reference to the environment 100 and may be performed by the computing architecture 200. Of course, the processes may be performed in other similar and/or different environments.

At 602, data from a first plurality of electronic devices may be synchronized into one or more data segments. For instance with reference to FIG. 1, video data provided by the one or more sensing devices may be synchronized at the storage location 102.

The method of synchronizing data at 602 may begin, at 604, with a plurality of capture devices which may be directed to commence capturing data from the plurality of data sources. For instance, the controller 110 may provide the indication to the capture cards to begin capturing the data provided by the sensing devices.

At 606, synchronizing the data may continue with the data captured by the individual data sources of the plurality being received by the plurality of capture devices.

At 608, synchronizing the data may continue with a plurality of capture devices which may be directed to discontinue capturing data from the plurality of data sources. For instance, the controller 110 may provide the indication to the capture cards to stop capturing the data provided by the sensing devices.

At 610, the one or more synchronized data segments may be output for storage. For instance, the data capture module may output the synchronized data segments to the data storage module once they are captured by the capture cards.

At 612, the one or more synchronized data segments may be stored. For instance, the data storage module may store the synchronized data segments in a datastore at the storage location and/or at a location remote from the storage location.

At 614, the stored one or more synchronized data segments may be presented to a plurality of electronic devices. For instance, the stored data segments may be presented to one or more portable electronic devices for viewing and/or presented to one or more data hosting services for editing.

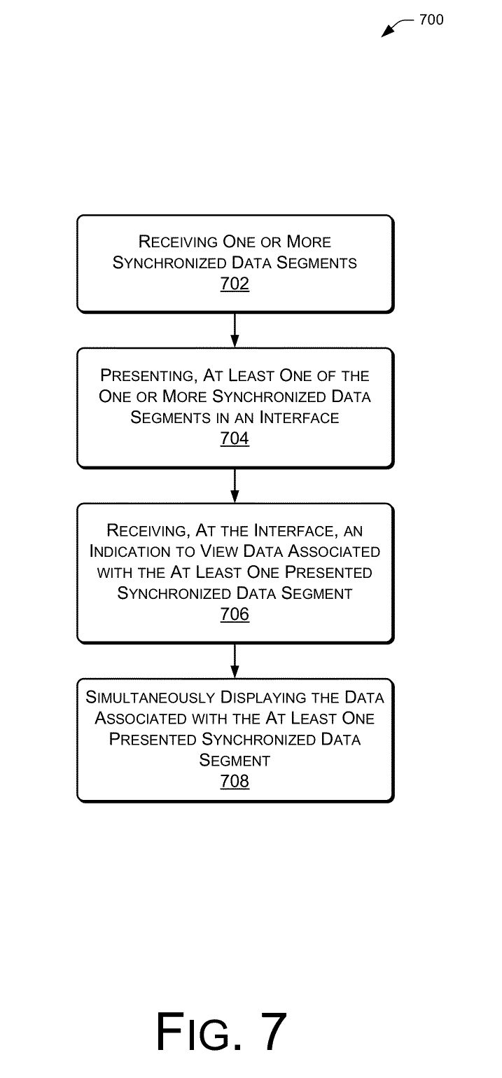

FIG. 7 is a flow diagram of an illustrative process 700 for implementing the techniques of receiving the synchronized data segments on an electronic device.

At 702, one or more synchronized data segments may be received. For instance, the one or more synchronized data segments may be received, over a network and from the data providing module, by a computing device.

At 704, at least one of the one or more synchronized data segments may be presented in an interface. For instance, one of the data segments have video from multiple vantage points may be presented in a user interface in an application running on a computing device.

At 706, an indication to view data associated with the at least one presented synchronized data segment may be receive at the interface. For instance, a user may provide an indication by touching a display screen presented in the interface to play the video data of the synchronized data segment.

At 708, the data associated with the at least one presented synchronized data segment may be simultaneously displayed. For instance, the video data of the synchronized data segments having video from the multiple data sources with different vantages may be played on the display screen of the computing device. In some implementations, the video data may be played simultaneously.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

What is claimed is:

1. A video recording system comprising:
one or more processors;
multiple video capture devices, wherein each of the video capture devices receives data from a different video source;
a video capture control communicatively coupled to the multiple video capture devices to simultaneously control the multiple video capture devices to produce one or more synchronous data segments by:
simultaneously initiating capturing of data by the multiple video capture devices from respective video sources responsive to selection of the video capture control; and
simultaneously discontinuing capturing of data by the multiple video capture devices from the respective video sources responsive to deselection of the video capture control; and
memory storing instructions executable by the one or more processors to store the one or more synchronous data segments in the memory.

2. The system as recited in claim 1, the system further comprising:
a network interface controller to provide the one or more synchronous data segments to one or more video hosting services after the one or more synchronous data segments are produced.

3. The system as recited in claim 1, wherein the multiple video capture devices each comprise at least one of a high definition multimedia interface (HDMI) capture card; a high definition serial digital interface (HD-SDI) video capture card; or a standard definition (SD) video capture card.

4. The system as recited in claim 1, wherein the data from each video source comprises video data of a same scene from a different vantage than each other video source.

5. A data capture system comprising:
one or more processors;
two or more data capture devices;
memory, coupled to the one or more processors;
a data capture module corresponding to the two or more data capture devices configured to create one or more synchronous data segments by:
causing each of the two or more data capture devices to initiate capture of data from multiple data sources;
causing each of the two or more data capture devices to stop capture of data from the multiple data sources;
a data providing module stored within the memory and executable by the one or more processors to provide the one or more synchronous data segments to at least one of:
one or more electronic devices for consumption; or
one or more data editing services.

6. The system as recited in claim 5, further comprising:
a data storage module stored within the memory and executable by the one or more processors to store the one or more synchronous data segments.

7. The system as recited in claim 5, wherein the synchronous data segments each comprise a portion of data captured by each of the two or more data capture devices between a first time of the received first indication and a second time of the received second indication.

8. The system as recited in claim 5, wherein the two or more data capture devices each comprise at least one of a high definition multimedia interface (HDMI) capture card; a high definition serial digital interface (HD-SDI) video capture card; or a standard definition (SD) video capture card.

9. The system as recited in claim 5, wherein the data capture module further comprises a controller coupled to the two or more data capture devices to simultaneously cause each of the two or more data capture devices to initiate capture of data from the multiple data sources.

10. The system as recited in claim 9, wherein the controller comprises a button which provides a visual signal that capture of data by each of the two or more data capture devices has been initiated.

11. The system as recited in claim 5, wherein a number of the multiple data sources corresponds to a number of the two or more data capture devices, and wherein each of the two or more data capture devices receives data from a particular data source located at a location different than another data source.

12. The system as recited in claim 5, wherein providing the one or more synchronous data segments to one or more electronic devices for consumption comprises transmitting the one or more synchronous data segments to an application stored on the one or more electronic devices, wherein the application is configured to allow simultaneous replay of data associated with at least one of the synchronous data segments and to receive edits to the data associated with the at least one of the synchronous data segments.

13. The system as recited in claim 5, wherein providing the one or more synchronous data segments to one or more data editing services occurs after the data capture module creates each of the synchronous data segments and without interaction with a user.

14. A method comprising:
under control of one or more computing systems configured with executable instructions,
synchronizing data from a plurality of data sources into one or more data segments, wherein synchronizing comprises dividing the data into one of the one or more data segments by:
directing a plurality of capture devices to commence capturing data from the plurality of data sources;
receiving, by the plurality of capture devices, the data provided by the individual data sources of the plurality of data sources;
directing one or more capture devices to discontinue capturing data from the plurality of data sources;
outputting, by the plurality of capture devices, the one or more synchronized data segments for storage by one or more computing devices; and
providing, by the one or more computing devices, the stored one or more synchronized data segments to one or more of electronic devices.

15. The method as recited in claim 14, wherein a number of the plurality of capture devices is equal to a number of the plurality of data sources.

16. The method as recited in claim 14, wherein each of the plurality of the capture devices is configured to receive data from a particular data source of the plurality of data sources.

17. The method as recited in claim 14, wherein each of the one or more data segments comprise a portion of data captured from each of the plurality of data sources between for a time frame corresponding to the directing to commence capturing data and directing to discontinue capturing data.

18. The method as recited in claim 14, wherein a first indication directing to commence capturing data and a second indication directing to discontinue capturing data are provided by a controller coupled to the one or more computing devices.

19. The method as recited in claim 14, wherein the data captured from the plurality of data sources comprises one of: video data without audio data or video data with audio data.

20. The method as recited in claim 14, wherein the one or more electronic devices comprises at least one of:
one or more portable electronic devices for consumption; or
one or more electronic devices of a data editing service.
